(19) United States
(12) Patent Application Publication
(10) Pub. No.: US 2008/0126399 A1
(43) Pub. Date: May 29, 2008

(54) METHOD AND APPARATUS FOR OPTIMIZING DATA WHILE PRESERVING PROVENANCE INFORMATION FOR THE DATA

(76) Inventor: Robert M. MacGregor, Manhattan Beach, CA (US)

Correspondence Address: PARK, VAUGHAN & FLEMING LLP, 2820 FIFTH STREET, DAVIS, CA, 95618-7759, US

(21) Appl. No.: 11/771,981

(22) Filed: Jun. 29, 2007

Related U.S. Application Data
(60) Provisional application No. 60/817,774, filed on Jun. 29, 2006.

(51) Int. Cl. G06F 3/048; G06F 7/00

(52) U.S. Cl. 707/102; 715/764; 707/E17.049

(57) ABSTRACT

One embodiment of the present invention provides a system that facilitates optimizing data within a data storage system while preserving provenance information for the data. During operation, the system receives a first data triple comprising a first subject, a first predicate, and a first object. Next, the system determines a provenance of the first data triple, wherein the provenance facilitates determining the source of the triple. The system then creates one or more first provenance triples comprising the provenance of the first data triple. Next, the system creates a first bridge triple comprising a first context, a “hasProvenance” predicate, and the first provenance, wherein the first bridge triple relates the first context to the first provenance. Finally, the system converts the first data triple into a first quadruple comprising the first subject, the first predicate, the first object, and the first context.

### RELATED APPLICATION

This application claims priority under 35 U.S.C. § 119(e) to U.S. Provisional Application Ser. No. 60/817,774, entitled “Scalable Representation of Provenance,” by inventor Robert M. MacGregor, filed on 29 Jun. 2006, the contents of which are herein incorporated by reference (Attorney Docket No. SIDE06-0001PSP).

### BACKGROUND

1. Field of the Invention

The present invention relates to data storage systems. More specifically, the present invention relates to a method and an apparatus for optimizing data within a data storage system while preserving provenance information for the data.

2. Related Art

Organizations are increasingly using the Resource Description Framework (RDF) to store data which is extracted from a variety of sources. During this process, text extractors extract statements from each source and store them in the RDF storage as triples, wherein each triple includes a subject, a predicate, and an object. These statements are then interrelated, managed, and used in a much more efficient manner than could be achieved by simply storing the sources of these statements.

The semantic underpinnings and inherent flexibility of RDF make RDF a much better medium for representing provenance information for data than alternative storage options such as relational databases or XML, wherein provenance information is information that relates each statement back to its source. However, neither triples, nor the more recent “named graph” schemes, are well-suited to large-scale use of provenance information. For example, provenance information for a given statement can include: a pointer to a source document, an offset within the source document where the statement was extracted, a time that the statement was extracted, a time the source document was created, etc.

As the amount of provenance information stored for each statement increases, the processing time for queries that interact with the RDF storage increases tremendously. For example, in an RDF storage system comprising millions of statements, such queries could have extremely long execution times, up to one of two orders of magnitude slower than would be the case querying an RDF storage system containing the same data minus the provenance information.

Hence, what is needed is a method and an apparatus for optimizing data within an RDF storage without the problems listed above.

### SUMMARY

One embodiment of the present invention provides a system that facilitates optimizing data within a data storage system while preserving provenance information for the data. During operation, the system receives a first data triple comprising a first subject, a first predicate, and a first object. Next, the system determines a provenance of the first data triple, wherein the provenance facilitates determining the source of the triple. The system then creates one or more first provenance triples comprising the provenance of the first data triple. Next, the system creates a first bridge triple comprising a first context, a “hasProvenance” predicate, and the first provenance, wherein the first bridge triple relates the first context to the first provenance. Finally, the system converts the first data triple into a first quadruple comprising the first subject, the first predicate, the first object, and the first context.

In some embodiments of the present invention, the system receives a second data triple comprising a second subject, a second predicate, and a second object. Next, the system determines a provenance for the second data triple. The system then creates one or more second provenance triples comprising the provenance of the second data triple. Next, the system creates a second bridge triple comprising a second context, a “hasProvenance” predicate, and the second provenance, wherein the second bridge triple relates the second context to the second provenance The system also converts the second data triple into a second quadruple comprising the second subject, the second predicate, the second object, and the second context. Finally, the system determines if the first quadruple is a duplicate of the second quadruple, which involves determining if the first subject, the first predicate, and the first object refer to the same entities as the second subject, the second predicate, and the second object, respectively. If so, the system performs a merging operation between the first quadruple and the second quadruple to produce a third quadruple.

In some embodiments of the present invention, the system performs the merging operation on the first quadruple and the second quadruple by creating the third quadruple comprising the first subject, the first predicate, the first object, and a third context. The system then creates a third bridge triple comprising the third context, the “hasProvenance” predicate, and the first provenance. The system also creates a fourth bridge triple comprising the third context, the “hasProvenance” predicate, and the second provenance. Finally, the system deletes the first quadruple and the second quadruple.

In some embodiments of the present invention, determining if the first quadruple is a duplicate of the second quadruple involves receiving a determination from a third party that an entity within the first quadruple is equivalent to an entity within the second quadruple, wherein an entity can include one of a subject, a predicate, and an object. The system then determines if remaining entities in the first quadruple are equivalent to remaining entities in the second quadruple.

In some embodiments of the present invention, determining if the first quadruple is a duplicate of the second quadruple involves receiving external inputs to aid in the determination that an entity within the first quadruple is equivalent to an entity within the second quadruple, wherein an entity can include one of a subject, a predicate, and an object. The system then determines if remaining entities in the first quadruple are equivalent to remaining entities in the second quadruple.

In some embodiments of the present invention, performing the merging operation between the first quadruple and the second quadruple only occurs upon receiving a merge instruction from a third party.

In some embodiments of the present invention, performing the merging operation between the first quadruple and the second quadruple only occurs upon receiving external inputs from a third party, wherein the external inputs aid in determining if the first quadruple and the second quadruple should be merged.

In some embodiments of the present invention, upon determining that the first quadruple is not a duplicate of the second quadruple, the system performs an unmerging operation on the third quadruple to reveal the first quadruple and the second quadruple.

In some embodiments of the present invention, the system receives a command from a user through a Graphical User Interface (GUI) to merge the first quadruple with the second quadruple. In response to the command, the system merges the first quadruple with the second quadruple to create the third quadruple.

In some embodiments of the present invention, the system receives a command from a user through a GUI to unmerge the third quadruple. In response to the command, the system unmerges the third quadruple to reveal the first quadruple and the second quadruple.

In some embodiments of the present invention, the quadruples are stored in a separate data store from provenance triples and bridge triples.

In some embodiments of the present invention, the data storage adheres to a Resource Description Framework (RDF) model.

In some embodiments of the present invention, the quadruples are n-tuples, and wherein n is greater than or equal to four.

Some embodiments of the present invention provide a computer-readable storage medium comprising a data structure which adheres to a Resource Description Framework (RDF) model. The data structure comprises a plurality of n-tuples, wherein each n-tuple in the plurality of n-tuples comprises: a subject, a predicate, an object, and a provenance. Furthermore, the provenance facilitates in identifying the source of the n-tuple.

### BRIEF DESCRIPTION OF THE FIGURES

FIG. 1 illustrates a computing environment in accordance with an embodiment of the present invention.

FIG. 2 presents a flow chart illustrating the process of creating RDF quadruples in accordance with an embodiment of the present invention.

FIG. 3 presents a flow chart illustrating the process of performing a merge operation in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The structures and code described in this detailed description are typically stored on a computer-readable storage medium, which may be any device or medium that can store code and/or for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

### Overview

One embodiment of the present invention provides a system that facilitates optimizing data within a data storage system while preserving provenance information for the data. During operation, the system receives a first data triple comprising a first subject, a first predicate, and a first object. Next, the system determines a provenance of the first data triple, wherein the provenance facilitates determining the source of the triple. The system then creates one or more first provenance triples comprising the provenance of the first data triple. Next, the system creates a first bridge triple comprising a first context, a “hasProvenance” predicate, and the first provenance, wherein the first bridge triple relates the first context to the first provenance. Finally, the system converts the first data triple into a first quadruple comprising the first subject, the first predicate, the first object, and the first context.

In some embodiments of the present invention, the system receives a second data triple comprising a second subject, a second predicate, and a second object. Next, the system determines a provenance for the second data triple. The system then creates one or more second provenance triples comprising the provenance of the second data triple. Next, the system creates a second bridge triple comprising a second context, a “hasProvenance” predicate, and the second provenance, wherein the second bridge triple relates the second context to the second provenance The system also converts the second data triple into a second quadruple comprising the second subject, the second predicate, the second object, and the second context. Finally, the system determines if the first quadruple is a duplicate of the second quadruple, which involves determining if the first subject, the first predicate, and the first object refer to the same entities as the second subject, the second predicate, and the second object, respectively. If so, the system performs a merging operation between the first quadruple and the second quadruple to produce a third quadruple.

Note that some embodiments of the present invention, to determine if the quadruples are duplicates, only the subject, the predicate, and the object are considered (the contents of the triples from which the quadruples were derived). It is assumed that for duplicate triples, the corresponding quadruples will never be true duplicates because the provenance information will be different.

In some embodiments of the present invention, the system performs the merging operation on the first quadruple and the second quadruple by creating the third quadruple comprising the first subject, the first predicate, the first object, and a third context. The system then creates a third bridge triple comprising the third context, the “hasProvenance” predicate, and the first provenance. The system also creates a fourth bridge triple comprising the third context, the “hasProvenance” predicate, and the second provenance. Finally, the system deletes the first quadruple and the second quadruple.

In some embodiments of the present invention, determining if the first quadruple is a duplicate of the second quadruple involves receiving a determination from a third party that an entity within the first quadruple is equivalent to an entity within the second quadruple (i.e. the entities are co-referent), wherein an entity can include one of a subject, a predicate, and an object. The system then determines if remaining entities in the first quadruple are equivalent to remaining entities in the second quadruple. In these embodiments, the co-reference of entities within Resource Description Framework (RDF) statements was determined prior to the statements being stored in the RDF storage. Note that this co-reference can take place at any time from the extraction of the RDF statements from their source to sometime subsequent to the storage of the RDF statements in the RDF storage system.

In some embodiments of the present invention, determining if the first quadruple is a duplicate of the second quadruple involves receiving external inputs to aid in the determination that an entity within the first quadruple is equivalent to an entity within the second quadruple, wherein an entity can include one of a subject, a predicate, and an object. The system then determines if remaining entities in the first quadruple are equivalent to remaining entities in the second quadruple.

In some embodiments of the present invention, performing the merging operation between the first quadruple and the second quadruple only occurs upon receiving a merge instruction from a third party.

In some embodiments of the present invention, performing the merging operation between the first quadruple and the second quadruple only occurs upon receiving external inputs from a third party, wherein the external inputs aid in determining if the first quadruple and the second quadruple should be merged.

In some embodiments of the present invention, upon determining that the first quadruple is not a duplicate of the second quadruple, the system performs an unmerging operation on the third quadruple to reveal the first quadruple and the second quadruple. Unmerging the RDF statements may be necessary if RDF statements were co-referenced and merged erroneously.

In some embodiments of the present invention, the system receives a command from a user through a Graphical User Interface (GUI) to merge the first quadruple with the second quadruple. In response to the command, the system merges the first quadruple with the second quadruple to create the third quadruple.

In some embodiments of the present invention, the system receives a command from a user through a GUI to unmerge the third quadruple. In response to the command, the system unmerges the third quadruple to reveal the first quadruple and the second quadruple.

In some embodiments of the present invention, the quadruples are stored in a separate data store from provenance triples and bridge triples. Note that this may be desirable to reduce query time when querying the data.

In some embodiments of the present invention, the data storage adheres to a Resource Description Framework (RDF) model.

In some embodiments of the present invention, the quadruples are n-tuples, and wherein n is greater than or equal to four. For example, in one embodiment of the present invention, the triples are converted into quintuples, wherein each quintuple comprises the subject, the predicate, the object, and two items of provenance. In another embodiment, the triples are converted into quintuples, wherein each quintuple comprises the subject, the predicate, the object, an item of provenance, and a security item.

Some embodiments of the present invention provide a computer-readable storage medium comprising a data structure which adheres to an RDF model. The data structure comprises a plurality of n-tuples, wherein each n-tuple in the plurality of n-tuples comprises: a subject, a predicate, an object, and a provenance. Furthermore, the provenance facilitates in identifying the source of the n-tuple.

### RDF Extracted from Text

Consider a document base containing articles about the software industry. In some instances, it is useful to use text extractors on the document base to capture information from the document base and store the captured information in a meaningful manner. The text extractors apply text extraction techniques to generate (structured) RDF statements from these documents. For example, if a document includes the phrase “Bill Gates, the co-founder of the U.S.-based company Microsoft Corporation . . . ”, a brand X text extractor might emit triples such as:

:person1 rdf:type foaf:Person .

:person1 ex:hasName “Bill Gates” .

:person1 ex:worksfor :organization2 .

:organization2 rdf:type ex:Organization .

:organization2 ex:hasName “Microsoft Corporation” .

:organization2 ex:locatedIn :country3 .

:country3 rdf:type ex:Country .

:country3 ex:hasName “U.S.” .

:country3 ex:hasName “United States” .

The text extractor processes each document independently of all other documents, so referents such as :person1, :organization2, or :country3 all have a scope limited to a single document. Hence, a blank-node representation most accurately captures the semantics of these resources. Suppose the following two fragments occur in another document: “Microsoft Corp. has . . . ,” and “company co-founder and chairman Bill Gates spoke to . . . ” This might yield the following extracted triples:

:person4 rdf:type foaf:Person .

:person4 ex:hasName “Bill Gates” .

:person4 dc:title “Chairman” .

:person4 ex:worksfor :company5 .

:company5 rdf:type ex:Company .

:company5 ex:hasName “Microsoft Corp.” .

:company5 ex:hasName “Microsoft Corporation” .

Note that the typical output of a text-extractor yields a localized set of statements about resources denoting persons, places, organizations, etc.

### Provenance

In many instances, it is useful to maintain the provenance of statements extracted from text documents. For each statement/triple, the system records what document the statement/triple came from. The system will typically also record the position within the document (a pair of offsets) of the phrase behind each statement. Additionally, the system may also record the security classification of a statement, the level of trust, a confidence level (probability), etc. It is quite possible that the provenance information will overshadow (in terms of size) the base information. For the present example, the system records a logical pointer from each statement to the source document that the statement came from.

The system can use “contexts” to supply the linkages needed from statements to provenance information. For each document, the system creates a new context that points at the document. Each new context corresponds to a “named graph,” with the statements extracted from that document constituting the statements/edges within the graph. For reasons that will become increasingly apparent, the system will use quadruple notation rather than named graph notation. For two documents with URLs “doc1URL” and “doc2URL,” the original statements, augmented with contexts/provenance, look like:

:person1 rdf:type foaf:Person :context1 .

:person1 ex:hasName “Bill Gates” :context1 .

:person1 ex:worksfor :organization2 :context1 .

:organization2 rdf:type ex:Organization :context1 .

:organization2 ex:hasName “Microsoft Corporation” :context1 .

:organization2 ex:locatedIn :country3:context1 .

:country3 rdf:type ex:Country :context1 .

:country3 ex:hasName “U.S.” :context1 .

:country3 ex:hasName “United States” :context1 .

:person4 rdf:type foaf:Person :context2 .

:person4 ex:hasName “Bill Gates” :context2 .

:person4 dc:title “Chairman” :context2 .

:person4 ex:worksfor :company5:context2 .

:company5 rdf:type ex:Company :context2 .

:company5 ex:hasName “Microsoft Corp.” :context2 .

:company5 ex:hasName “Microsoft Corporation” :context2 .

:context1 rdf:type ex:Context .

:context1 dc:source “doc1URL” .

:context2 rdf:type ex:Context .

:context2 dc:source “doc2URL” .

Note that the last four statements are still in triple form rather than in quadruple form. In an embodiment of the present invention, each model comes with a “base context” that serves as the value of the context-position argument for each triple that doesn't explicitly state a context argument.

Currently circulating proposals for contexts and/or named graphs are primarily about semantic rather than syntactic representation of provenance. For purposes of the present invention, syntax is the primary concern, especially as it relates to machine performance. The present invention's use of a quadruple notation is the first step in achieving a syntax that scales. Early experiments with quad-based provenance resembled the scheme illustrated above. However, with the introduction of aggressive co-reference resolution in combination with increasing numbers of statements, that scheme broke down.

### Co-Reference Resolution

The value of the RDF dataset is significantly increased if co-reference relationships are introduced that recognize all references to Bill Gates as denoting the same person, all references to Microsoft as denoting the same organization/company, and all references to the United States as denoting the same country, etc. Assume that a co-reference recognizer applied to the above statements yields the following additional triples:

:person1 owl:sameAs person4 .

:organization2 owl:sameAs company5 .

In many applications, inferred co-reference relationships such as those just illustrated are an integral part of the application. Before continuing the discussion on co-reference, it is necessary to delve deeper into how to reason with equivalence relationships. In some embodiments of the present invention, a backward-chaining implementation for reasoning with owl:sameAs statements is built in to the RDF engine. The system may also implement a destructive merge operation for handling equivalence. For example: Let E represent a set of two or more resources that are asserted to be equivalent (i.e., the closure of owl:sameAs causes each pair of members of E to be linked by an owl:sameAs). The destructive merge operates by: choosing one member e of E (a resource) to represent all members of the set, destructively rewriting all attributes that reference any member of E to instead reference e, and then discarding all resources that have been stripped of their attributes. Applying a merge operator to the quadruples listed above, and then regrouping to cluster by predicate yields:

:person1 rdf:type foaf:Person :context1 .

:person1 rdf:type foaf:Person :context2 .

:person1 ex:hasName “Bill Gates” :context1 .

:person1 ex:hasName “Bill Gates” :context2 .

:person1 ex:worksfor :organization2 :context1 .

:person1 ex:worksfor :organization2 :context2 .

:person1 dc:title “Chairman” :context2 .

:organization2 rdf:type ex:Organization :context1 .

:organization2 rdf:type ex:Company :context2 .

:organization2 ex:hasName “Microsoft Corporation” :context1 .

:organization2 ex:hasName “Microsoft Corp.” :context2 .

:organization2 ex:hasName “Microsoft Corporation” :context2 .

:organization2 ex:locatedIn :country3 :context1 .

:country3 rdf:type ex:Country :context1 .

:country3 ex:hasName “U.S.” :context1 .

:country3 ex:hasName “United States” :context1 .

:context1 rdf:type ex:Context .

:context1 dc:source “doc1URL” .

:context2 rdf:type ex:Context .

:context2 dc:source “doc2URL” .

Note that for this particular provenance scheme, the merge operation is lossless—the system can undo a merge if needed.

Notice that there are several pairs of quadruples that differ only in the value of their context argument—they have the same subject/predicate/object (SPO) values. The system refers to a set of quadruples having the same SPO values as “duplicate quadruples.” Duplicate quadruples can appear in any set of named graphs, but they are particularly numerous when co-reference relationships are prevalent.

Consider a typical dataset containing around 2,000 documents that include two hundred (200) references to “United States” (or variants such as “US”), fifty (50) references to “Microsoft Corp” (or “Microsoft”). and ten (10) references to “Bill Gates,” where the system is counting only one reference per entity per document. The two hundred blank nodes each denoting the United States may all state that the United States has rdf:type ex:Country, and they will likely have ex:hasName attributes with values of “United States” “U.S.,” or “US.” The fifty Microsoft blank nodes will be typed as ex:Organization or ex:Company, and will mostly have ex:hasName attributes with values “Microsoft Corporation,” “Microsoft Corp.,” or “Microsoft.” The extracted references to Bill Gates will also have duplicate type and duplicate hasName attributes. There may also be other predicates (e.g., dc:title) with duplicate values. When co-reference merging is applied, significant numbers of duplicate quadruples result.

From a semantic standpoint, duplicate quadruples represent a natural phenomenon that seems relatively harmless. However, in one experiment when a system applied merging operations to an RDF/OWL dataset of around 1,500 documents, the system noticed a slowdown factor of ten in query response time. Two factors contributed to the impaired performance: (1) The average fan-out of resources in the merged dataset was very much higher than that for the original dataset, so loops within the query executor were iterating over much larger numbers of matches. (2) Attributes that normally would have only one or two values now had many values, so query filters specifying fixed values for the predicate and value positions of a clause were now much more expensive to evaluate.

To correct the problem, the present invention uses a duplicate removal operation that collapses sets of duplicate quadruples to eliminate the duplicates. Applying duplicate removal in the experiment above completely restored query performance.

### Removing Duplicate Quadruples

It is important when removing duplicate quadruples to do so while preserving provenance information. Duplicate quadruple removal involves a merging operation applied to contexts. Consider the following pair of duplicate quadruples, plus associated provenance information:

:person1 ex:worksfor :organization2 :context1 .

:person1 ex:worksfor :organization2 :context2 .

:context1 dc:source “doc1URL” .

:context2 dc:source “doc2URL” .

To eliminate the duplication, the system creates a new context, :context3, having the union of the provenance information in :context1 and :context2, and substitutes the new context in, resulting in the following statements:

:person1 ex:worksfor :organization2 :context3 .

:person1 ex:worksfor :organization2 :context3 .

:context1 dc:source “doc1URL” .

:context2 dc:source “doc2URL” .

:context3 dc:source “doc1URL” .

:context3 dc:source “doc2URL” .

The system now has a truly duplicate pair of quadruples, which simplifies to:

:person1 ex:worksfor :organization2 :context3 .

:context1 dc:source “doc1URL” .

:context2 dc:source “doc2URL” .

:context3 dc:source “doc1URL” .

:context3 dc:source “doc2URL” .

Hence, the duplicate problem is gone. Unfortunately, the scheme just outlined is lossy. To see how, consider an example where provenance information includes not only document URLs, but also an offset to the location within a document where the reference occurs. The starting example looks like:

:person1 ex:worksfor :organization2 :context1 .

:person1 ex:worksfor :organization2 :context2 .

:context1 dc:source “doc1URL” .

:context1 ex:offset 42 .

:context2 dc:source “doc2URL” .

:context2 ex:offset 103 .

Applying the duplicate removal operation yields:

:person1 ex:worksfor :organization2 :context3 .

:context1 dc:source “doc1URL” .

:context1 ex:offset 42 .

:context2 dc:source “doc2URL” .

:context2 ex:offset 103 .

:context3 dc:source “doc1URL” .

:context3 ex:offset 42 .

:context3 dc:source “doc2URL” .

:context3 ex:offset 103 .

Unfortunately, after the context merge, it is impossible to say, for the provenance data attached to :context3, which offset is paired with which URL. To make our merge operation lossless, it is necessary to add an extra level of linkage between our statements and the corresponding provenance information. This is accomplished by adding a new “provenance” object, and a pointer from the context object to the provenance object named pvc:provenance. The before-duplicate-removal example now looks like this:

:person1 ex:worksfor :organization2 :context1 .

:person1 ex:worksfor :organization2 :context2 .

:context1 pvc:provenance provenance1 .

:context2 pvc:provenance provenance2 .

:provenance1 dc:source “doc1URL” .

:provenance1 ex:offset 42 .

:provenance2 dc:source “doc2URL” .

:provenance2 ex:offset 103 .

After duplicate removal, the example appears as:

:person1 ex:worksfor :organization2 :context3 .

:context1 ex:provenance provenance1 .

:context2 ex:provenance provenance2 .

:context3 ex:provenance provenance1 .

:context3 ex:provenance provenance2 .

:provenance1 dc:source “doc1URL” .

:provenance1 ex:offset 42 .

:provenance2 dc:source “doc2URL” .

:provenance2 ex:offset 103 .

This scheme is lossless (with respect to the context merging operation), and is more modular than the simpler lossy version.

### Semantics for Contexts and Provenance

The following is a simple ontology that defines one scheme for representing contexts and provenance:

pvc:Context rdf:type rdfs:Class .

pvc:Provenance rdf:type rdfs:Class .

pvc:provenance rdf:type rdf:Property .

pvc:provenance rdfs:domain pvc:Context .

pvc:provenance rdfs:range pvc:Provenance .

The existence of an explicit “Provenance” class encourages the definition of multiple provenance ontologies. For example, one may wish to define a SourceProvenance class, a subclass of Provenance that has attributes dc:source and ex:offset. Additionally, one might define a SecurityProvenance class that has security attributes attached.

In this construction, a context is defined by the pvc:Provenance instances attached to it via pvc:provenance edges. For example, :context3 above is defined as having exactly two provenances, :provenance1 and :provenance2. If one were to define another context :context4 by the following triples:

:context4 pvc:provenance provenance1 .

:context4 pvc:provenance provenance2 .

then the system would consider :context3 and :context4 to be “the same”. This is important, because it sanctions a context merge operation. The system can merge the two contexts into a single context without changing the meaning of the model. Model “clean-up” operators can apply context merging to reduce the space requirements for a provenance-laden model.

For purposes of the present invention, the “definition” of context assumes a closed-world assumption with respect to those edges, which is not consistent with RDF/OWL thinking. The context is really an aggregate, a set of provenance objects.

Instead of defining a context by the set of statements/edges that it includes, the system considers a context to be defined by the pvc:Provenance instances attached to it via pvc:provenance links. Philosophically, this means that a context is all about the “scope” in which a statement should be interpreted. The traditional notion of context within the logic community refers to a model-like entity about which one can define super-graph/sub-graph relations, apply lifting axioms, define inheritance rules, etc. Both of these notions are valid; the present invention just happens to find provenance to be vitally important to the applications, and has oriented the syntax to optimize provenance reasoning.

### Scalability

The co-reference resolution operation logically converts a (sparse) graph into a denser one. The destructive merge operation physically increases the density of a graph, where “density” is measured by the ratio of edges to nodes. The duplicate removal operation was invented to combat this increase in graph density. Query performance worsens as graph density increases, so it is intuitive that the duplicate removal process should have a significantly beneficial effect on performance.

In real-world applications involving text extraction coupled with co-reference resolution, over a fixed domain the expected number of references to a particular real-world entity increases linearly with the number of documents. That means that if you double the number of documents, you double both the expected number of statements and (in the absence of duplicate removal) you double the expected density. From a scalability standpoint, this is a recipe for disaster. It basically means that provenance schemes syntactically analogous to Named Graphs are inherently non-scalable with respect to this paradigm.

When “document offsets” are introduced into our provenance scheme, the number of contexts necessarily becomes equal to the number of statements (triples). Put another way, if one were to use Named Graphs to represent the provenance, all of the graphs would be singleton graphs. The notion that space allocated for provenance information could be many times the space allocated for triples (ordinary statements) may be troublesome. In the future, provenance mechanisms may be ripe for compression schemes (e.g., resorting to relational table-like representations to encode the provenance).

It is evident empirically that backward-chaining equivalence reasoning doesn't scale. The tricks that have been outlined above to reduce graph density do not work in backward-chaining mode. Also, the presence of very large numbers of equivalent blank nodes pollutes any RDF viewer used in conjunction with a backward chainer (these nodes all have the same attributes, so some kind of duplicate blank node removal process needs to be instituted).

The traditional argument against the kind of destructive merge discussed above is that it is too aggressive; you cannot back out if you decide you want to undo a specific equivalence statement. However, if the merge is lossless, then backing out is always possible (assuming that an unmerge operator has been implemented). However, there is still one niche where using backward-chaining equivalence makes sense. Equivalence relations tied to modals (e.g., “:person1 and :person2 are the same with probability 0.8”) cannot be forward-chained the way crisp assertions can. Reasoning fluently with more than one modal equivalence assertion may entail maintaining some form of multiple-worlds environment, for which non-destructive reasoning is more compatible.

Triples Vs. Quadruples

Unlike RDF triples, there is no standard for quadruples. However, the drawbacks to triple-based schemes are many. Moreover, as described above, there are serious practical obstacles to schemes based on Named Graphs.

When scale is not an issue, it appears that the RDF field is open for a variety of competing schemes for implementing contexts and provenance. However, at sizes of a few million statements, serious performance problems exist with the more naive provenance schemes. Analysis of the syntactic structure of those schemes indicates that the problems will grow more severe as the number of statements increases. It appears that scalability concerns place severe constraints on which schemes are practical. In contrast, the present invention defines a provenance scheme that exhibits good scaling properties.

### Computing Environment

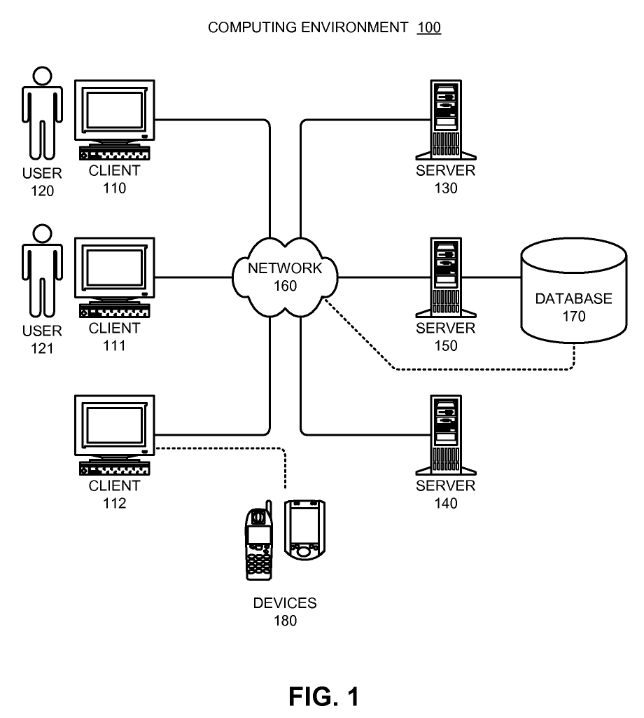

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, servers 130-150, network 160, database 170, and devices 180.

Clients 110-112 can include any node on a network including computational capability and including a mechanism for communicating across the network.

Similarly, servers 130-150 can generally include any node on a network including a mechanism for servicing requests from a client for computational and/or data storage resources.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled to a server (such as server 150), to a client, or directly through a network.

Devices 180 can include any type of electronic device that can be coupled to a client, such as client 112. This includes, but is not limited to, cell phones, Personal Digital Assistants (PDAs), smart-phones, personal music players (such as MP3 players), gaming systems, digital cameras, portable storage media, or any other device that can be coupled to the client. Note that in some embodiments of the present invention, devices 180 can be coupled directly to network 160 and can function in the same manner as clients 110-112.

In one embodiment of the present invention, database 170 is a Resource Description Framework (RDF) storage system. In some embodiments of the present invention, database 170 stores both RDF data, as well as the source documents for the RDF data.

### Creating RDF Quadruples

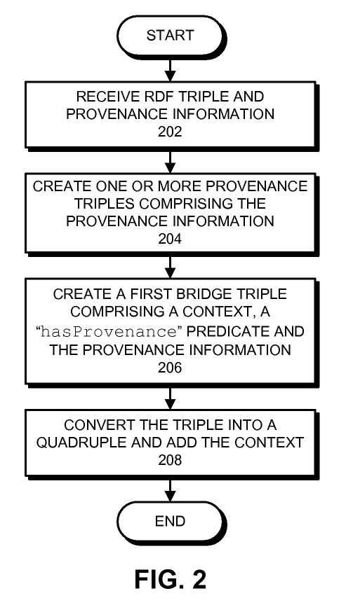

FIG. 2 presents a flow chart illustrating the process of creating RDF quadruples in accordance with an embodiment of the present invention. During operation, the system receives an RDF triple and provenance information (operation 202). Note that the triple and the provenance can be received from a text extractor, a third party, a user, or any other source. The system then creates one or more provenance triples that comprise the provenance of the triple (operation 204). Next, the system creates a bridge triple comprising a context, a “hasProvenance” predicate, and the provenance information (operation 206), wherein the first bridge triple relates the context to the provenance information. Finally, the system converts the triple into a quadruple and adds the context (operation 208).

### Merging RDF Quadruples

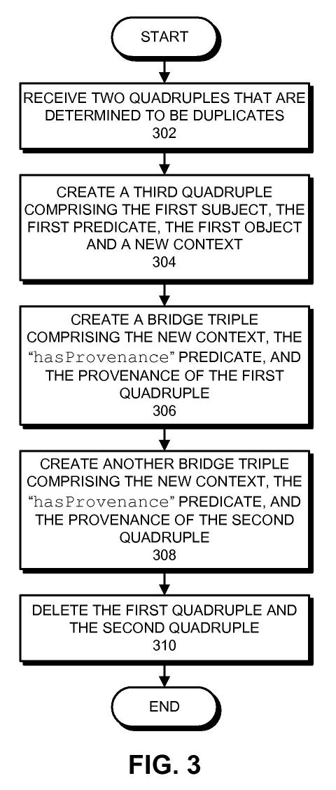

FIG. 3 presents a flow chart illustrating the process of performing a merge operation in accordance with an embodiment of the present invention. During operation, the system receives two quadruples that are determined to be duplicates (operation 302). Note that the system can determine that two quadruples are duplicates, as well receiving a determination from an external source that two quadruples are duplicates.

Next, the system creates a third quadruple comprising: the first subject, the first predicate, the first object, and a new context (operation 304). Note that the third quadruple could comprise the second subject, the second predicate, the second object, and a new context because the first and second quadruples have been determined to have the same subjects, predicates, and objects.

The system then creates a bridge triple comprising: the new context, the “hasProvenance” predicate, and the provenance of the first quadruple (operation 306). The system also creates another bridge triple comprising: the new context, the “hasProvenance” predicate, and the provenance of the second quadruple (operation 308). Finally, the system deletes the first quadruple and the second quadruple (operation 310).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for optimizing data within a data storage system while preserving provenance information for the data, the method comprising:
receiving a first data triple comprising a first subject, a first predicate, and a first object;
determining a first provenance of the first data triple, wherein the first provenance facilitates determining the source of the first data triple;
creating one or more first provenance triples comprising the first provenance;
creating a first bridge triple comprising a first context, a “hasProvenance” predicate, and the first provenance, wherein the first bridge triple relates the first context to the first provenance; and
converting the first data triple into a first quadruple comprising the first subject, the first predicate, the first object, and the first context.

2. The method of claim 1, further comprising:
receiving a second data triple comprising a second subject, a second predicate, and a second object;
determining a second provenance of the second data triple;
creating one or more second provenance triples comprising the second provenance;
creating a second bridge triple comprising a second context, the “hasProvenance” predicate, and the second provenance, wherein the second bridge triple relates the second context to the second provenance;
converting the second data triple into a second quadruple comprising the second subject, the second predicate, the second object, and the second context;
determining if the first quadruple is a duplicate of the second quadruple, which involves determining if the first subject, the first predicate, and the first object refer to the same entities as the second subject, the second predicate, and the second object, respectively; and
if so, performing a merging operation between the first quadruple and the second quadruple to produce a third quadruple.

3. The method of claim 2, wherein performing the merging operation on the first quadruple and the second quadruple involves:
creating the third quadruple comprising the first subject, the first predicate, the first object, and a third context;
creating a third bridge triple comprising the third context, the “hasProvenance” predicate, and the first provenance;
creating a fourth bridge triple comprising the third context, the “hasProvenance” predicate, and the second provenance; and
deleting the first quadruple and the second quadruple.

4. The method of claim 2, wherein determining if the first quadruple is a duplicate of the second quadruple involves:
receiving a determination from a third party that an entity within the first quadruple is equivalent to an entity within the second quadruple, wherein an entity can include one of a subject, a predicate, and an object; and
determining if remaining entities in the first quadruple are equivalent to remaining entities in the second quadruple.

5. The method of claim 2, wherein determining if the first quadruple is a duplicate of the second quadruple involves:
receiving external inputs to aid in the determination that an entity within the first quadruple is equivalent to an entity within the second quadruple, wherein an entity can include one of a subject, a predicate, and an object; and
determining if remaining entities in the first quadruple are equivalent to remaining entities in the second quadruple.

6. The method of claim 2, wherein performing the merging operation between the first quadruple and the second quadruple only occurs upon receiving a merge instruction from a third party.

7. The method of claim 2, wherein performing the merging operation between the first quadruple and the second quadruple only occurs upon receiving external inputs from a third party, wherein the external inputs aid in determining if the first quadruple and the second quadruple should be merged.

8. The method of claim 2, wherein upon determining that the first quadruple is not a duplicate of the second quadruple, the method further comprises performing an unmerging operation on the third quadruple to reveal the first quadruple and the second quadruple.

9. The method of claim 2, further comprising:
receiving a command from a user through a Graphical User Interface (GUI) to merge the first quadruple with the second quadruple;
in response to the command, merging the first quadruple with the second quadruple to create the third quadruple.

10. The method of claim 2, further comprising:
receiving a command from a user through a Graphical User Interface (GUI) to unmerge the third quadruple;
in response to the command, unmerging the third quadruple to reveal the first quadruple and the second quadruple.

11. The method of claim 1, wherein the quadruples are stored in a separate data store from provenance triples and bridge triples.

12. The method of claim 1, wherein the data storage adheres to a Resource Description Framework (RDF) model.

13. The method of claim 1, wherein the quadruples are n-tuples, and wherein n is greater than or equal to four.

14. A computer-readable storage medium storing instructions that when executed by a computer cause the computer to perform a method for optimizing data within a data storage system while preserving provenance information for the data, the method comprising:
receiving a first data triple comprising a first subject, a first predicate, and a first object;
determining a first provenance of the first data triple, wherein the first provenance facilitates determining the source of the first data triple;
creating one or more first provenance triples comprising the first provenance;
creating a first bridge triple comprising a first context, a “hasProvenance” predicate, and the first provenance, wherein the first bridge triple relates the first context to the first provenance; and
converting the first data triple into a first quadruple comprising the first subject, the first predicate, the first object, and the first context.

15. The computer-readable storage medium of claim 14, wherein the method further comprises:
receiving a second data triple comprising a second subject, a second predicate, and a second object;
determining a second provenance of the second data triple;
creating one or more second provenance triples comprising the second provenance;
creating a second bridge triple comprising a second context, the “hasProvenance” predicate, and the second provenance, wherein the second bridge triple relates the second context to the second provenance;
converting the second data triple into a second quadruple comprising the second subject, the second predicate, the second object, and the second context;
determining if the first quadruple is a duplicate of the second quadruple, which involves determining if the first subject, the first predicate, and the first object refer to the same entities as the second subject, the second predicate, and the second object, respectively; and
if so, performing a merging operation between the first quadruple and the second quadruple to produce a third quadruple.

16. The computer-readable storage medium of claim 15, wherein performing the merging operation on the first quadruple and the second quadruple involves:
creating the third quadruple comprising the first subject, the first predicate, the first object, and a third context;
creating a third bridge triple comprising the third context, the “hasProvenance” predicate, and the first provenance;
creating a fourth bridge triple comprising the third context, the “hasProvenance” predicate, and the second provenance; and
deleting the first quadruple and the second quadruple.

17. The computer-readable storage medium of claim 15, wherein determining if the first quadruple is a duplicate of the second quadruple involves:
receiving a determination from a third party that an entity within the first quadruple is equivalent to an entity within the second quadruple, wherein an entity can include one of a subject, a predicate, and an object; and
determining if remaining entities in the first quadruple are equivalent to remaining entities in the second quadruple.

18. The computer-readable storage medium of claim 15, wherein determining if the first quadruple is a duplicate of the second quadruple involves:
receiving external inputs to aid in the determination that an entity within the first quadruple is equivalent to an entity within the second quadruple, wherein an entity can include one of a subject, a predicate, and an object; and
determining if remaining entities in the first quadruple are equivalent to remaining entities in the second quadruple.

19. The computer-readable storage medium of claim 15, wherein performing the merging operation between the first quadruple and the second quadruple only occurs upon receiving a merge instruction from a third party.

20. The computer-readable storage medium of claim 15, wherein performing the merging operation between the first quadruple and the second quadruple only occurs upon receiving external inputs from a third party, wherein the external inputs aid in determining if the first quadruple and the second quadruple should be merged.

21. The computer-readable storage medium of claim 15, wherein upon determining that the first quadruple is not a duplicate of the second quadruple, the method further comprises performing an unmerging operation on the third quadruple to reveal the first quadruple and the second quadruple.

22. The computer-readable storage medium of claim 15, wherein the method further comprises:
receiving a command from a user through a Graphical User Interface (GUI) to merge the first quadruple with the second quadruple;
in response to the command, merging the first quadruple with the second quadruple to create the third quadruple.

23. The computer-readable storage medium of claim 15, wherein the method further comprises:
receiving a command from a user through a Graphical User Interface (GUI) to unmerge the third quadruple;
in response to the command, unmerging the third quadruple to reveal the first quadruple and the second quadruple.

24. The computer-readable storage medium of claim 14, wherein the quadruples are stored in a separate data store from provenance triples and bridge triples.

25. The computer-readable storage medium of claim 14, wherein the data storage adheres to a Resource Description Framework (RDF) model.

26. The computer-readable storage medium of claim 14, wherein the quadruples are n-tuples, and wherein n is greater than or equal to four.

27. An apparatus configured to optimize data within a data storage system while preserving provenance information for the data, comprising:
a receiving mechanism configured to receive a first data triple comprising a first subject, a first predicate, and a first object;
a determination mechanism configured to determine a provenance of the first data triple, wherein the provenance facilitates determining the source of the first data triple;
a creation mechanism configured to create one or more first provenance triples comprising the provenance of the first data triple;
wherein the creation mechanism is further configured to create a first bridge triple comprising a first context, a “hasProvenance” predicate, and the first provenance, wherein the first bridge triple relates the first context to the first provenance; and
a conversion mechanism configured to convert the first data triple into a first quadruple comprising the first subject, the first predicate, the first object, and the first context.

28. A computer-readable storage medium comprising:
a data structure which adheres to a Resource Description Framework (RDF) model, wherein the data structure comprises a plurality of n-tuples, and wherein each n-tuple in the plurality of n-tuples comprises:
a subject,
a predicate,
an object, and
a provenance, wherein the provenance facilitates in identifying the source of the n-tuple.
